(19) United States
(12) Patent Application Publication
(10) Pub. No.: US 2008/0222736 A1
(43) Pub. Date: Sep. 11, 2008

(54) Scrambling HTML to prevent CSRF attacks and transactional crimeware attacks

(75) Inventors: Michael Boodaei, Givatayim (IL); Amit Klein, Hertsliya (IL)

Correspondence Address: MERCHANT & GOULD PC, P.O. BOX 2903, MINNEAPOLIS, MN, 55402-0903, US

(73) Assignee: TRUSTEER LTD., Ramat-Gan (IL)

(21) Appl. No.: 11/714,933

(22) Filed: Mar. 7, 2007

(51) Int. Cl. G06F 7/04

(52) U.S. Cl. 726/27

(57) ABSTRACT

The present invention relates to a method for preventing an unauthorized activity including a transaction in a web site comprising the steps of: (a) receiving a response containing at least one HTML page, from said site, by the traffic processor; (b) modifying said response by obfuscating said at least one HTML page of said response; (c) storing de-obfuscation information in a transaction table; (d) forwarding the modified response from said traffic processor to the client's browser; (e) redirecting a request from said browser to the traffic processor, by the redirector; (f) checking said request for an unauthorized command; (g) de-obfuscating said request using the stored information in said transaction table; and (h) forwarding the modified request to said site.

### FIELD OF THE INVENTION

The present invention relates to the field of Internet security, secure browsing, and secure eCommerce. More particularly, the invention relates to a method for preventing an unauthorized activity such as a transaction, in a protected web site, which uses CSRF (Cross Site Request Forgeries), Cross Site Scripting, or Malicious browser plug-ins for exploiting the victim's browser.

### BACKGROUND OF THE INVENTION

A computer executing a browser, referred to hereinafter as a Web Client or client, is essentially a hyper text reader communicating with a Web Server via a specific data transfer protocol such as a Hyper Text Transfer Protocol (HTTP). Any hyper text file on the web is uniquely identified by its Universal Resource Locator (URL). Many of the hyper text files are currently structured using the Hyper Text Mark-up Language (HTML) which may also be used for calling hyper text data objects. The hyper text data object may be in the form of any information medium including a text, an image, a voice, a moving picture or an executable computer program. When a client requests a hyper text file, using the file's URL, the file is displayed on the client's browser, where the display is commonly known as a web page. The client can return data to the server and call a Common Gateway Interface (CGI) program on the server computer to perform a specific task.

One of the problems concerning Internet security today involves unauthorized transactional acts where the browser of a victim, while surfing a protected web site such as a bank account, can be forced to conduct online transactions by exploiting known Internet security deficiencies.

One of the ways to conduct an unauthorized transaction is by Cross Site Request Forgeries (CSRF), sometimes abbreviated as XSRF, and also known as “Client Side Trojans” or “Session Riding”. In a CSRF attack, the victim's browser is forced, while browsing a protected web site, to navigate to a malicious URL that represents a transaction. Forcing the browser to navigate to this URL can be the result of either enticing the victim to click on a “seemingly innocent” link, by having the client browse another site simultaneously, or when reading email through an HTML-enabled mail software, force the browser by means of HTML (and Javascript) to navigate to the malicious URL. The malicious URL is either embedded as an IMG link or a similar HTML tag that automatically loads the URL, or provided as a Javascript code that loads the URL e.g. through a call to the window.open( ) function.

Another way to conduct an unauthorized transaction is by “Cross Site Scripting”. This attack exploits a vulnerability of the targeted web site, which allows the attacker to craft a malicious link (in the target web site) and entice the user to click it. Once the user clicks this link, the attacker's Javascript/VBscript code runs at the user's browser in the context of the web site. This malicious code can conduct an unauthorized transaction, sometimes in a different window of the same web site. In Cross Site Scripting, the attacker manages to run his own Javascript/VBscript code in the context of the protected web site. This enables more elaborate attacks, such as ones that require access to the response (e.g. reading forms), and sending multiple requests. Cross Site Scripting is therefore more powerful than CSRF, but requires a cross site scripting vulnerability at the protected web site. On the other hand, this is still a remote attack, meaning it does not require the victim to run native code on his machine.

A third way to conduct an unauthorized transaction is by implementing in the client a “Malicious browser plug-in”. The malicious browser, plug-in (e.g. BHO technology in Microsoft Internet Explorer) monitors login form submissions, and once the user is logged in, the plug-in forces the browser to navigate to the transaction URL. This represents the most powerful attack method; however, it requires the attacker to have the client run the attacker's malicious code on the native operating system.

As of today, some techniques to combat CSRF attacks are available, none of which offer a complete solution to the problem, for example: Referer checking-which is the act of verifying that the Referer header of an incoming HTTP request contains a URL from within the same domain, thus ensuring that the URL was requested as a result of a legitimate request associated with a link/form from the same domain. Nevertheless, this method is unreliable, as some clients ironically turn off the Referer at their browser, for security and privacy reasons. Furthermore, recent research demonstrates' that the Referer can be completely spoofed, e.g. from within a Flash plug-in. And lastly, there are many situations in which a browser normally doesn't send a Referer header. Another method for combating CSRF is POST requests—by ensuring that the site only handles POST requests, some standard CSRF methods, such as embedding the malicious URL inside an IMG tag or its like, can be defeated because these HTML tags result in a GET request, never in a POST request.—However, while slightly harder to emulate via CSRF, the POST requests are still very feasible in CSRF. Moving to POST requests doesn't buy a lot of protection. Another way for combating CSRF is by adding a security token (sometimes called “ticket”) to the form (see e.g. http://shiflett.org/articles/foiling-cross-site-attacks) this can actually eliminate the risk, but it is ineffective against the stronger cross-site scripting and malware attacks.

As for preventing Cross Site Scripting, in general, most attempts used today are carried out at the server side, e.g. by sanitizing input and encoding output. However, no silver bullet has so far emerged, and Cross Site Scripting attacks are still prevalent among all attacks reported. Some attempts were made to suggest browser measures to confine and contain the effect of cross site scripting (e.g. “Content Restrictions” and “Script Keys” by Gervase Markham, http://www.gerv.net/security/content-restrictions/ and http://www.gerv.net/security/script-keys/, respectively), but these methods remain at this time experimental and have never made it into the core of any major browser.

As to the virus/spyware/Trojan/malware problem, one approach applied by the Anti-virus and anti-spyware vendors for combating client side threats (such as malicious browser plug-ins), is detection through signatures, meaning that any virus/spyware/Trojan/malware detected by the vendors is identified and marked by a unique signature for detection. Yet this reactive approach is unlikely to detect a threat until it was (1) noticed several times by the vendors, (2) analyzed in the vendors' lab and a signature identifying the threat is developed, and (3) the signature is distributed to the clients. This process can take many hours, sometimes days, thereby opening a window large enough for the threat to operate. Although heuristics and generalization techniques (“behavioral analysis”) exist, they are far from being effective, as the attacker can study them at his convenience and come up with ways to avoid detection.

It is an object of the present invention to provide a method for preventing an unauthorized activity such as a transaction.

It is another object of the present invention to provide a method for preventing an unauthorized activity such as a transaction applied by Cross Site Request Forgeries, Cross Site Scripting or Malicious browser plug-ins.

Other objects and advantages of the invention will become apparent as the description proceeds.

### SUMMARY OF THE INVENTION

The present invention relates to a method for preventing an unauthorized activity including a transaction in a web site comprising the steps of: (a) detecting a submission of a first request from the client's browser to said site; (b) redirecting, by the redirector, said first request to the traffic processor for monitoring said first request; (c) forwarding said first request from said traffic processor to said site; (d) receiving a response containing at least one HTML page, from said site, by said traffic processor; (e) modifying said response by obfuscating said at least one HTML page of said response; (f) storing de-obfuscation information in a transaction table; (g) forwarding the modified response from said traffic processor to said browser; (h) redirecting a second request from said browser to said traffic processor by said redirector; (i) checking said second request for an unauthorized command; (j) de-obfuscating said second request using the stored information in said transaction table; and (k) forwarding the modified second request to said site.

In one of the embodiments the transaction table stores de-obfuscation information of more than one HTML page.

Preferably, the forwarding of the request(s) by the traffic processor and the receiving of response(s) from the site is done using a secure path.

Preferably, the first request from the client's browser is the login request.

Preferably, when the unauthorized command is detected a log event or an alert event is triggered.

Preferably, either the user, the web site, the operator of the service, or a 3rd party entity, is alerted when an unauthorized command is detected.

Preferably, the obfuscation of the HTML page is performed using one or more of the following techniques: adding user invisible forms/links, changing the form action, adding user invisible form parameters, renaming form parameters, changing the form/link order in the DOM, moving forms/links from the static HTML, changing the forms/links at runtime, adding client side code for encryption, changing some of the page text to an image, a series of images or a distorted image.

The present invention also relates to a method for preventing an unauthorized activity including a transaction in a web site comprising the steps of: (a) receiving a response containing at least one HTML page, from said site, by the traffic processor; (b) modifying said response by obfuscating said at least one HTML page of said response; (c) storing de-obfuscation information in a transaction table; (d) forwarding the modified response from said traffic processor to the client's browser; (e) redirecting a request from said browser to the traffic processor, by the redirector; (f) checking said request for an unauthorized command; (g) de-obfuscating said request using the stored information in said transaction table; and (h) forwarding the modified request to said site.

The present invention also relates to a method for preventing an unauthorized activity including a transaction in a web site comprising the steps of: (a) redirecting, by the redirector, a first request from the client's browser to the traffic processor for monitoring said first request; (b) forwarding said first request from said traffic processor to said site; (c) receiving a response containing at least one HTML page, from said site, by the traffic processor; (d) modifying said response by obfuscating said at least one HTML page of said response; (e) storing de-obfuscation information in a transaction table; (f) forwarding the modified response from said traffic processor to said browser; (g) redirecting a second request from said browser to said traffic processor by said redirector; (h) checking said second request for an unauthorized command; (i) de-obfuscating said second request using the stored information in said transaction table; and (j) forwarding the modified second request to said site.

The present invention also relates to a method for preventing an unauthorized activity including a transaction in a web site comprising the steps of: (a) receiving a response containing at least one HTML page, from said site, by the traffic processor; (b) modifying said response by obfuscating said at least one HTML page of said response; (c) storing de-obfuscation information in a transaction table; (d) forwarding the modified response from said traffic processor to the client's browser; (e) receiving a request from said browser to said traffic processor; (f) checking said request for an unauthorized command; (g) de-obfuscating said request using the stored information in said transaction table; and (h) forwarding the modified request to said site.

In one of the embodiments the traffic processor resides on the client.

In another embodiment the traffic processor resides on a server.

In yet another embodiment the traffic processor resides on the ISP.

In another embodiment the obfuscation of the HTML page is performed by manipulating the DOM.

### BRIEF DESCRIPTION OF THE DRAWINGS

In the drawings:

FIG. 1 is a schematic diagram of the system according to one of the embodiments of the invention.

FIG. 2 is a block diagram illustrating the method of the invention according to one of the embodiments.

FIG. 3 is a schematic diagram of the system according to another embodiment of the invention.

FIG. 4 is an example of a conventional method HTML web page received from a protected site

FIG. 5 shows the method according to the present invention wherein the response page shown in FIG. 4 from the bank is modified.

### DETAILED DESCRIPTION OF PREFERRED EMBODIMENTS

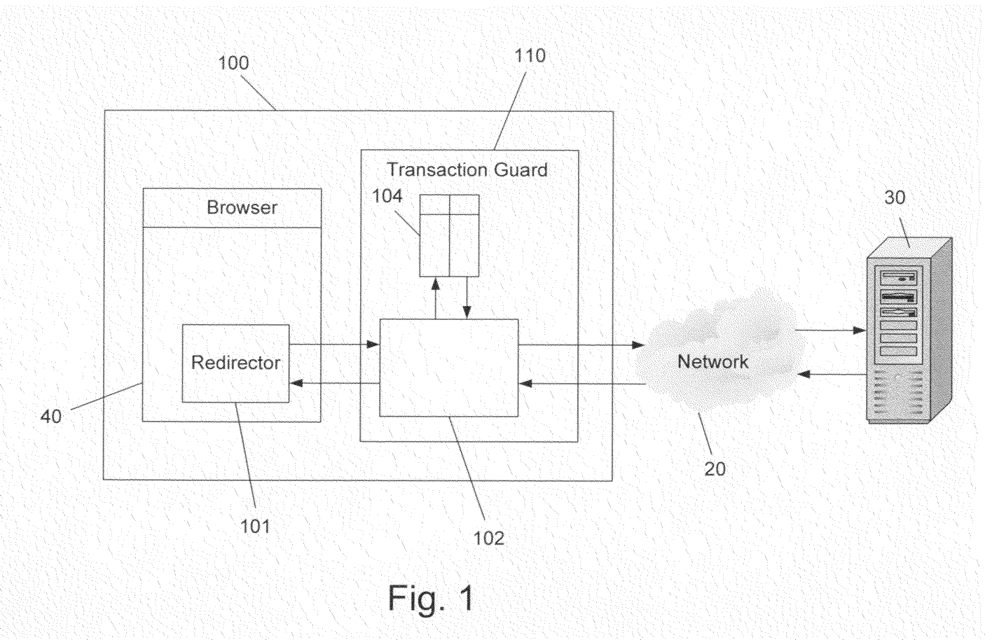

FIG. 1 is a schematic diagram of the system according to one of the embodiments of the invention. In the diagram, client 100 executes a browser 40 when surfing a Network 20 to web server 30. The redirector 101 is installed in browser 40 in order to avert the communication into Transaction Guard 110, installed on the client 100, when the browser communicates with a protected site. The Transaction Guard 110 purpose is to obfuscate the transactional elements sent from the protected web page, e.g. forms and links, such that the page logic becomes incomprehensible to a malicious code, yet at the same time the page layout, as seen by the user, does not change. In this embodiment Transaction Guard 110 comprises 2 components: Transaction Table 104 for storing and mapping the forms/links obfuscation parameters in the HTML of the protected web site, and Traffic Processor 102 which monitors and manipulates the HTTP traffic.

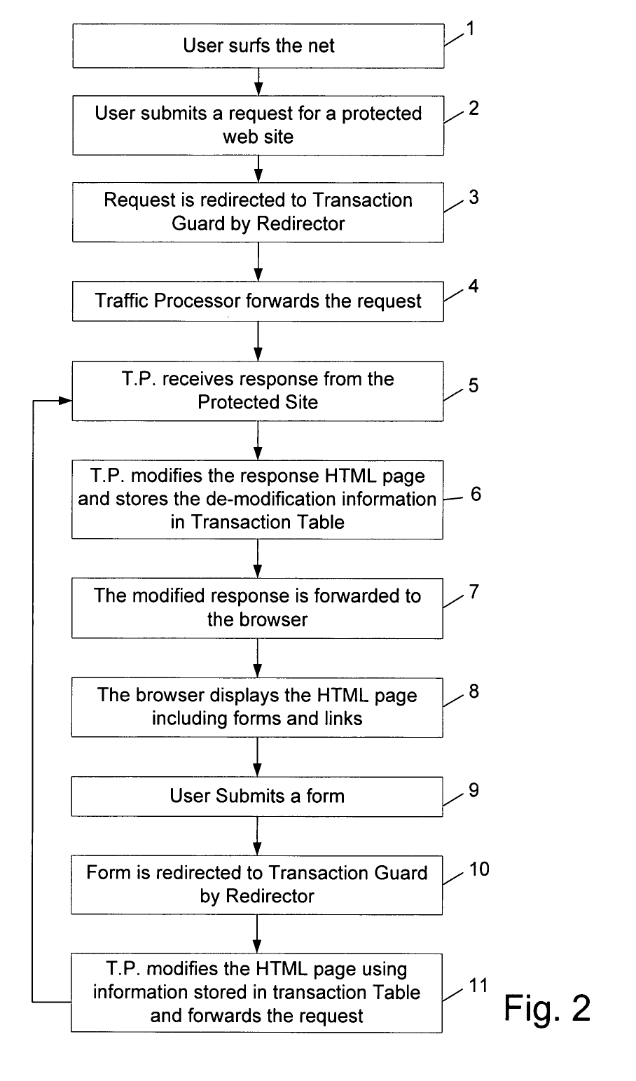

FIG. 2 is a block diagram illustrating the method of the invention according to one of the embodiments. The method is described in relations to FIG. 1. In step 1 the user of client 100 surfs the Network 20 and visits web server 30. In step 2 the user submits a request, using his browser 40, to surf a protected web site hosted by server 30. In step 3 the Redirector 101 detects the user's attempt to transmit the request to the protected web site, and it redirects the request to Transaction Guard 110. In step 4 the Traffic Processor (TP) 102 forwards the request to the protected site. In step 5 TP 102 receives the response from the site, where the response contains an HTML page, possibly containing forms or links. In step 6 the TP 102 modifies the HTML page by obfuscating all the necessary forms and links, where the de-obfuscation information is stored in Transaction Table 104. The term obfuscation is used hereinafter to describe the process of modifying an HTML page in such a way that on one hand it is harder for a malicious program to comprehend but on the other hand does not change the overall display of the web site to the user. Examples of obfuscation techniques are described in the next paragraph. In step 7 the modified response is forwarded to browser 40. In step 8 the browser 40 displays the obfuscated web page which should be displayed to the user similarly to the original sent web page. In step 9 the user may fill and submit a form in the displayed web page, or fulfill any other web interaction. In step 10 the Redirector 101 once again redirects the user's request, possibly containing the submitted form, to the Transaction Guard 110. In step 11 the TP 102 de-obfuscates the user's request using the de-obfuscation information of Transaction Table 104. At this point TP 102 also monitors the request and checks that no unauthorized transaction commands have been added. If TP 102 detects an unauthorized transaction command, possibly issued using one of the techniques described before for conducting an unauthorized transaction, than the user may be notified and/or the command may be deleted. After checking the request TP 102 forwards the user's request to the protected site. When a response is received from the protected site it is handled as described in relations to steps 5-7. The method, as described in relation to steps 5-11, may be repeated indefinitely until the user logs out of the protected site or terminates his connection.

For the sake of brevity a number of obfuscation techniques, which may be used for this invention, are described:
1. Adding user “invisible” forms/links similar to the ones found in the originally sent web page.
2. Changing the form action by adding random strings, or by changing the name of the path to a meaningless name, or by switching the name of the path to the name of another action.
3. Adding user “invisible” form parameters (including an unpredictable token/ticket-like parameter).
4. Renaming form parameters.
5. Changing the form/link order in the DOM. The DOM is the Document Object Module—a tree representation of the HTML tags and data, which the browser parses from the HTML and maintains internally.
6. Moving forms/links from the static HTML to be added to the DOM at the Javascript “runtime”. This can be achieved either by embedding Javascript, VBscript, or any other client-side language code, in the response page that adds data (HTML tags, partial tags or HTML data) to the HTML stream, or by embedding Javascript (or VBscript, etc.) code in the response page that writes directly to the DOM tree that is maintained by the browser, adding HTML nodes to this DOM tree.
7. Changing the forms/links at runtime from Javascript.
8. Changing some of the page text to an image or a series of images.
9. Changing some of the page text to a distorted (CAPTCHA-like) image or a series thereof.
10. Adding client side code (e.g. Javascript, VBScript) for encryption, which upon submission by the user, the submission data is encrypted.

Using the above described obfuscation techniques prevent unauthorized activities including transactions, as the attacker, e.g. using CSRF, Tojan/malware etc., cannot know in advance the form for submission and cannot devise a URL or a client side code that appears like a matching form for submission.

As understood, other obfuscation techniques known in the art may be used in this invention, and the invention may be carried out using a single obfuscation technique or a combination thereof.

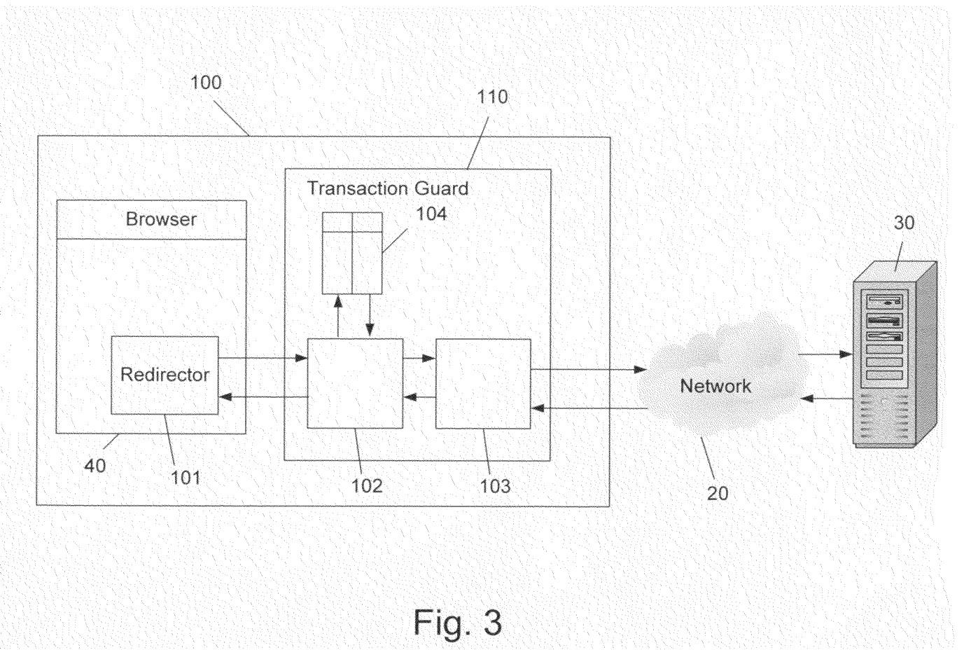

FIG. 3 is a schematic diagram of the system according to another embodiment of the invention. In the diagram, client 100 executes a browser 40 when surfing the Network 20 to web server 30. Redirector 101 is a module that forces the browser to avert the traffic transmitted to and from the protected site through Transaction Guard 110. Redirector 101 can be implemented by a browser plug-in (e.g. BHO) that modifies the URL call to a protected site, e.g. “Rapport://”, together with registering this scheme to the browser 40 as pointing at the Transaction Guard 110.

Other myriad ways of implementing Redirector 101 are possible, such as hooking/replacing the existing HTTP and HTTPS protocol handlers, or hooking into a lower level protocol API such as Windows' WinInet. The browser 40 “initiates” the HTTP/HTTPS requests, but it typically delegates the actual handling to lower-level libraries/modules such as WinInet and/or protocol handlers. A preferred Redirector 101 implementation is therefore to interject in the flow of data from the browser 40 to the lower-level libraries and redirect the traffic to the Transaction Guard 110. Transaction Guard 110 is the main module of the system, where its role is to obfuscate the HTML pages received from the protected web site. In this embodiment Transaction Guard 110 is comprised of 3 components: Transaction Table 104, Secure Path 103, and Traffic Processor 102. Transaction Table 104 manages the de-obfuscation data. It is essentially a table for mapping the de-obfuscation data of each page sent from the protected site. Secure Path 103 is essentially a stand-alone HTTP+SSL protocol stack. The Secure Path 103 enables the Transaction Guard 110 to issue any HTTP/HTTPS request, requiring only TCP/IP services from the operating system. By incorporating the close-set and tightly integrated HTTP+SSL stack of secure path 103, Transaction Guard 110 guarantees that no adversary activity can take place in the dispatching phase, i.e. once the logical request has been prepared, and before it is fully encrypted. The Secure Path 103 may be implemented by means of using open source libraries such as OpenSSL and cURL. Traffic Processor 102 implements most of the logic, meaning that it monitors HTTP traffic and can manipulate HTTP requests and HTTP responses, including monitoring and manipulating the HTML pages, in order to obfuscate or de-obfuscate the HTML page.

### EXAMPLE

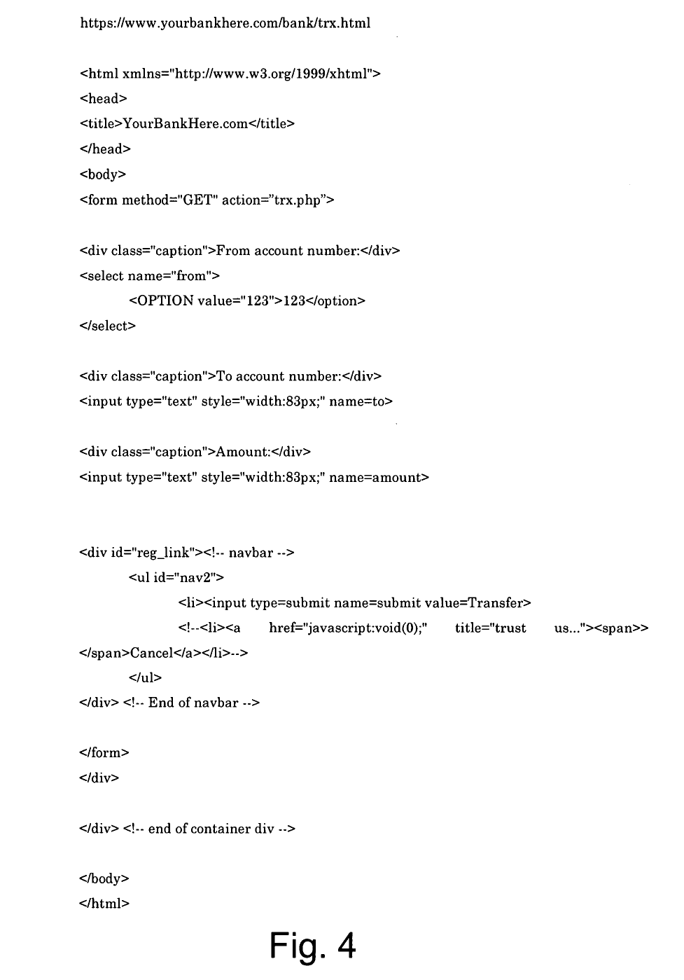

An example of a conventional method HTML web page received from a protected site is set forth in FIG. 4, the example shows a “Transfer money” page.

As can be seen in FIG. 4, a CSRF attacker, or a Trojan/malware program, can “inject” a request to https://www.yourbankhere.com/bank/trx.php?from=123&to =666&amount=9999.99, in order to transfer $9999.99 from account 123 (the account number of the victim user now logged in) to account 666 (the account number of the attacker).

### Method of the Invention:

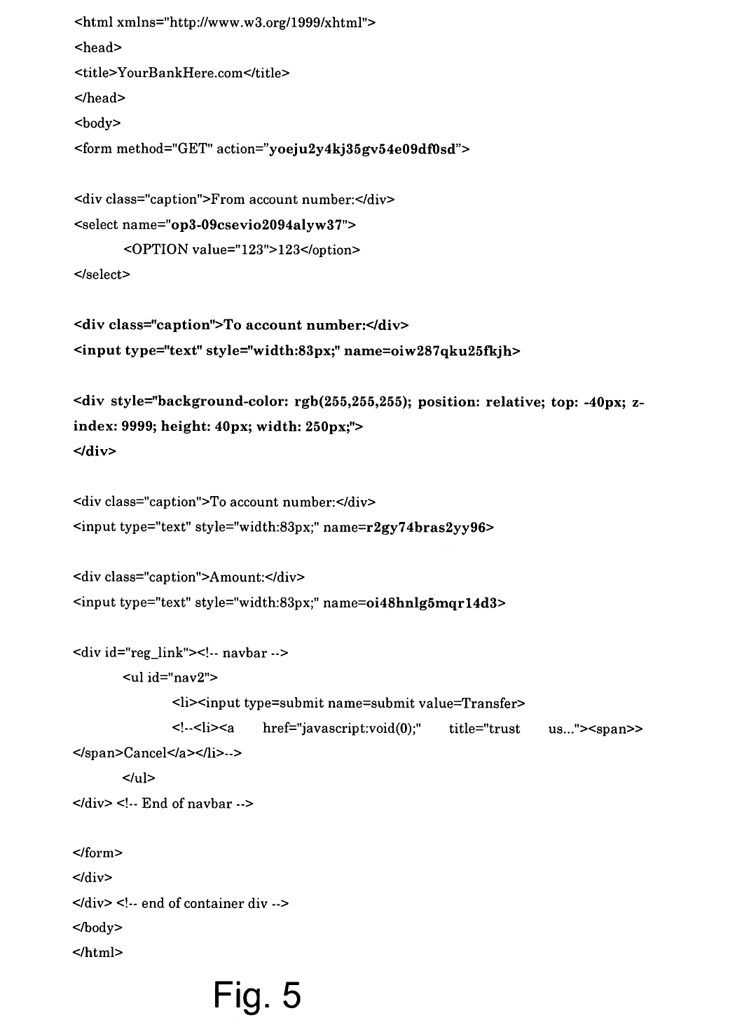

FIG. 5 shows the method of the invention where the same response page (of FIG. 4) from the bank is modified and obfuscated by the Traffic Processor, and the browser receives the depicted HTML page where the modifications are marked in bold. Note that the form action URL is modified—it is no longer a comprehensible name such as “trx.php”, but rather a random string (yoeju2y4kj35gv54e09df0sd). Likewise, form field names are obfuscated—e.g. r2gy74bras2yy96 instead of “to” and oi48hnlg5mqr14d3 instead of “amount”. This makes it much harder for malicious software to comprehend which fields it should change to which values. Finally, notice the additional HTML markup just before the definition of the “To” field:

<div class=“caption”>To account number:</div>
<input type=“text” style=“width:83px;” name=oiw287qku25fkjh>
<div style=“background-color: rgb(255,255,255); position: relative;
top: −40px; z-index: 9999; height: 40px; width: 250px;”>
</div>

The first block defines an input field much like the original “To” field. It looks like a TEXT input box, and is indistinguishable from the original “To” field (which is renamed r2gy74bras2yy96). However, right after this block, there's another block containing HTML instruction to overlay this input field with a blank rectangle. The net effect is that the user sees nothing, yet from a machine perspective, there is actually another input box, indistinguishable from the original input boxes. This technique is used to defeat software attempting to match the original form structure with the modified form structure.

In one of the embodiments, any activity that appears not to arrive from the user, such as submitting invisible forms/links, attempting to use the wrong set of parameters, etc., triggers a log event and/or an alert event. The user, and/or the target web site, and/or the operator of the service, and/or a 3rd party entity may be alerted or otherwise informed of this possible attack incident.

In another embodiment, the browser interface, such as Microsoft Internet Explorer's IWebBrowser2 COM interface, is used to manipulate the DOM after it is populated by the browser. In this embodiment, the DOM manipulation does not have to be part of the response page processing, and can be carried out asynchronously until the browser finishes building the DOM. Such manipulation can be on-going frequently, e.g. once every 100 milliseconds, replacing a form field. When the form is submitted, the field value provided can be compared with the value written to it. Since the processes in the computer takes typically few milliseconds only, it is likely that a genuine submission will provide a field value identical or relatively close to the one stored in the form, e.g. less than 100 milliseconds ago. On the other hand, when a Trojan parses the page, or sends the page to be rendered on a distant computer and waits to receive the response from that distant computer, the form submission is likely to be delayed with respect to the time the DOM field was read. This delay causes the trojan submission to include an old field value of the form, while the ongoing DOM update process has already updated the field with a new value. Hence it is possible to detect that the form was read “too long” ago (e.g. more than 100 milliseconds) before it was actually submitted.

In one of the embodiments, the method of the invention uses the IWebBrowser2 COM interface to access the DOM of the Microsoft Internet Explorer browser in order to manipulate the response received from a protected site. In this embodiment, the method of the invention may be carried out without monitoring the first request sent from the user to the protected site. The method begins by querying the DOM to see that the URL of the incoming response belongs to a protected site. After which the DOM can be further inspected to see if it contains some designated forms/links. At this stage the DOM can be modified in various ways described above (e.g. addition/modification of DOM elements such as submission URLs, form field names, etc.). When the user submits a form, the submission data can now be de-obfuscated in accordance to the obfuscation techniques applied to the DOM via the IWebBrowser2 COM interface.

In another embodiment the Transaction Guard is implemented outside the client, such as: server-side implementation, or possibly at the ISP (Internet Service Provider) side using a transparent proxy architecture, or on a router architecture. Meaning that the request/response traffic is still routed through the Traffic Processor, wherever it is implemented, either directly, e.g. when the Traffic Processor is in the data path, or using a Redirector to intercept the traffic and move it through the Traffic Processor. Nevertheless, as far as the browser is concerned, the Traffic Processor is a “façade” for the actual web server, much like a reverse proxy server, or a load balancer, or even a router/firewall.

In another embodiment the proxy settings are used to force the browser to communicate through the Traffic Processor, which may be implemented on the client or on any other machine, thus ridding the need to implement and deploy the Redirector component, typically, at the price of losing some transparency, since the browser is now aware of the existence of the proxy server.

While some embodiments of the invention have been described by way of illustration, it will be apparent that the invention can be carried into practice with many modifications, variations and adaptations, and with the use of numerous equivalents or alternative solutions that are within the scope of persons skilled in the art, without departing from the spirit of the invention or exceeding the scope of the claims.

1. A method for preventing an unauthorized activity including a transaction in a web site comprising the steps of:
a. detecting a submission of a first request from the client's browser to said site;
b. redirecting, by the redirector, said first request to the traffic processor for monitoring said first request;
c. forwarding said first request from said traffic processor to said site;
d. receiving a response containing at least one HTML page, from said site, by said traffic processor;
e. modifying said response by obfuscating said at least one HTML page of said response;
f. storing de-obfuscation information in a transaction table;
g. forwarding the modified response from said traffic processor to said browser;
h. redirecting a second request from said browser to said traffic processor by said redirector;
i. checking said second request for an unauthorized command;
j. de-obfuscating said second request using the stored information in said transaction table; and
k. forwarding the modified second request to said site.

2. A method according to claim 1 wherein the transaction table stores de-obfuscation information of more than one HTML page.

3. A method according to claim 1 wherein the forwarding of the request(s) by the traffic processor and the receiving of response(s) from the site is done using a secure path.

4. A method according to claim 1 wherein the first request from the client's browser is the login request.

5. A method according to claim 1 wherein when an unauthorized command is detected a log event or an alert event is triggered.

6. A method according to claim 5 wherein the user, or the web site, or the operator of the service, or a 3rd party entity are alerted when an unauthorized command is detected.

7. A method according to claim 1 wherein the obfuscation of the HTML page is performed using one or more of the following techniques: adding user invisible forms/links, changing the form action, adding user invisible form parameters, renaming form parameters, changing the form/link order in the DOM, moving forms/links from the static HTML, changing the forms/links at runtime, adding client side code for encryption, changing some of the page text to an image, a series of images or a distorted image.

8. A method for preventing an unauthorized activity including a transaction in a web site comprising the steps of:
a. receiving a response containing at least one HTML page, from said site, by the traffic processor;
b. modifying said response by obfuscating said at least one HTML page of said response;
c. storing de-obfuscation information in a transaction table;
d. forwarding the modified response from said traffic processor to the client's browser;
e. redirecting a request from said browser to said traffic processor by the redirector;
f checking said request for an unauthorized command;
g. de-obfuscating said request using the stored information in said transaction table; and
h. forwarding the modified request to said site.

9. A method for preventing an unauthorized activity including a transaction in a web site comprising the steps of:
a. redirecting, by the redirector, a first request from the client's browser to the traffic processor for monitoring said first request;
b. forwarding said first request from said traffic processor to said site;
c. receiving a response containing at least one HTML page, from said site, by the traffic processor;
d. modifying said response by obfuscating said at least one HTML page of said response;
e. storing de-obfuscation information in a transaction table;
f forwarding the modified response from said traffic processor to said browser;
g. redirecting a second request from said browser to said traffic processor by the redirector;
h. checking said second request for an unauthorized command;
i. de-obfuscating said second request using the stored information in said transaction table; and
j. forwarding the modified second request to said site.

10. A method for preventing an unauthorized activity including a transaction in a web site comprising the steps of:
a. receiving a response containing at least one HTML page, from said site, by the traffic processor;
b. modifying said response by obfuscating said at least one HTML page of said response;
c. storing de-obfuscation information in a transaction table;
d. forwarding the modified response from said traffic processor to the client's browser;
e. receiving a request from said browser by said traffic processor;
f checking said request for an unauthorized command;
g. de-obfuscating said request using the stored information in said transaction table; and
h. forwarding the modified request to said site.

11. A method according to claim 10 wherein the traffic processor resides on the client.

12. A method according to claim 10 wherein the traffic processor resides on a server.

13. A method according to claim 10 wherein the traffic processor resides on the ISP.

14. A method according to claim 10 wherein the obfuscation of the HTML page is performed by manipulating the DOM.
